(19) United States
(12) Patent Application Publication
(10) Pub. No.: US 2011/0169863 A1
(43) Pub. Date: Jul. 14, 2011

(54) TRANSMISSION TERMINAL, DISPLAY APPARATUS, IMAGE DISPLAY TRANSMISSION SYSTEM PROVIDED WITH THE TRANSMISSION TERMINAL AND THE DISPLAY APPARATUS, AND DATA TRANSFER METHOD IMPLEMENTED IN THE SYSTEM

(76) Inventor: Yasuji Kawai, Tokyo (JP)

(21) Appl. No.: 12/998,120

(22) PCT Filed: Sep. 30, 2008
(86) PCT No.: PCT/JP2008/067741

§ 371 Date: Mar. 18, 2011

(51) Int. Cl. G09G 5/00

(52) U.S. Cl. 345/637

(57) ABSTRACT

The present invention is for quickly performing image display in an image display system comprising a transmission terminal including an image accumulation section accumulating multiple image data the display order of which is specified, and a display apparatus connected to the transmission terminal via a network and including a cache data accumulation section accumulating multiple image data sent from the data transmission terminal and a display device displaying images of the image data accumulated in the cache data accumulation section. There are provided: a storage section accumulating a forward direction feeding mode, indicating the display order that is to be executed, and a backward direction feeding mode, indicating the display order that is to be executed is the reverse, in accordance with which the display order of the multiple image data is applied, and a control rule for each mode; and a data control section referring to contents accumulated in the data cache data accumulation section and the mode and the control rule accumulated in the data storage section to perform control so that image data at display order positions lower than the image data of a particular image currently displayed on the data display device are accumulated in the data cache data accumulation section.

### TECHNICAL FIELD

The present invention relates to an image display system provided with a transmission terminal which transmits image data to a display apparatus via a network and the display apparatus which performs display with the use of the received image data, and a data transfer system implemented in the image display system.

### BACKGROUND ART

Recently, the functions of a mobile terminal such as a mobile phone have been remarkably developed, and it has become possible to display a document or image created by a personal computer on the screen of the mobile terminal. Furthermore, a mobile terminal is provided with a variety of communication functions, and it becomes easier to connect to various information processing apparatuses in an office via a wireless LAN, a Bluetooth network or the like.

As it becomes easier for a mobile terminal to connect to various information processing apparatuses in an office, a situation is conceivable in which an information processor is caused to perform processing by an instruction from a mobile terminal. For example, it is conceivable to instruct printing of an image from a mobile terminal to a printer or to instruct projection of an image to a projector.

A technique for, when instructing a printer to print an image from a mobile terminal, displaying the image to be printed on the mobile terminal is disclosed, for example, in JP2006-163794A.

In the technique disclosed in JP2006-163794A, a large-size image assumed to be displayed on a personal computer is transmitted to a printer from a mobile terminal that is connected to the printer; the image received by the printer is reduced to a size which can be displayed on the mobile terminal and transmitted to the mobile terminal; and the reduced image is displayed on the mobile terminal.

An example can be given of a system that is used for a meeting or a presentation in which a mobile terminal instructs a projector to display an image from the mobile terminal.

In a meeting or presentation, multiple images the display order of which is predetermined are sequentially displayed. When a system user performs input specifying an image to be displayed, to a transmission terminal in which multiple image data to be displayed are accumulated, the specified image data is transmitted from the transmission terminal to the projector, and display based on the image data is performed by the projector.

### DISCLOSURE OF THE INVENTION

### Problems to be Solved by the Invention

In the case of a system for transmitting image data to a printer, among systems performing transmission of image data via a network, temporal restrictions do not especially occur. In the case of transmitting image data to a projector, and especially in the case of using a projector for a meeting or presentation, it is necessary to quickly transmit the image data.

In a transmission system via a wireless network having a relatively narrow band, such as a Bluetooth network, transmission of image data requires a lot of time. Therefore, when an operator executes a page feeding operation, a page is not displayed until a predetermined time before completion of transmission of the data of the page elapses, and the system is not user-friendly.

Therefore, a method in which a projector collectively accumulates multiple image data, such as buffering, is adopted. In buffering that has been conventionally performed, IDs indicating display order positions are given to multiple image data accumulated in a transmission terminal, and image data at display order positions after the currently displayed image data are collectively transmitted.

In a meeting or presentation, however, it is often the case that explanation is repeated by returning to an image used previously, depending on the contents of explanation. In such a case, since specified image data is sent each time, much time is required for data transmission, and much time is required before the specified image is displayed.

### Means for Solving the Problems

The present invention has been made in view of the problems of the related art, and it provides a technique for realizing a transmission terminal and a display apparatus, an image display transmission system provided with the transmission terminal and the display apparatus, and a data transfer method performed in the system which are capable of quickly performing image display.

The image display system according to the present invention is an image display system comprising a transmission terminal including an image accumulation section accumulating multiple image data the display order of which is specified, and a display apparatus connected to the transmission terminal via a network and including a cache data accumulation section accumulating multiple image data sent from the transmission terminal and a display device displaying images of the image data accumulated in the cache data accumulation section, wherein the display device displays a particular image in response to an instruction input to the transmission terminal to the effect that the particular image is to be displayed, the image display system being characterized in comprising:

a storage section accumulating a forward direction feeding mode, indicating the display order that is to be executed, and a backward direction feeding mode, indicating the display order that is to be executed is the reverse, in accordance with which the display order of the multiple image data is applied, and a control rule for each mode; and

a data control section referring to contents accumulated in the cache data accumulation section and the mode and the control rule accumulated in the storage section to perform control so that image data at display order positions lower than the image data of a particular image currently displayed on the display device are accumulated in the cache data accumulation section.

The transmission terminal according to the present invention is a transmission terminal connected to a display apparatus including a cache data accumulation section accumulating received multiple image data and a display device displaying images of the image data accumulated in the cache data accumulation section via a network to constitute an image display system, the transmission terminal comprising an image accumulation section accumulating multiple image data the display order of which is specified and which are to be transmitted to the display apparatus and causing a particular image to be displayed on the display device in response to an instruction input to the effect that the particular image is to be displayed, and the transmission terminal being characterized in comprising:

a storage section accumulating a forward direction feeding mode, indicating the display order that is to be executed, and a backward direction feeding mode, indicating the display order that is to be executed is the reverse, in accordance with which the display order of the multiple image data is applied, and a control rule for each mode; and

a data control section referring to contents accumulated in the cache data accumulation section and the mode and the control rule accumulated in the storage section to perform control so that image data at display order positions lower than the image data of a particular image currently displayed on the display device are accumulated in the cache data accumulation section.

The display apparatus according to the present invention is a display apparatus connected to a transmission terminal including an image accumulation section accumulating multiple image data the display order of which is specified, via a network, to constitute an image display system, and comprising a cache data accumulation section accumulating multiple image data sent from the transmission terminal and a display device displaying images of the image data accumulated in the cache data accumulation section, the display device displaying a particular image in response to an instruction input to the transmission terminal to the effect that the particular image is to be displayed, and the image display apparatus being characterized in comprising:

a storage section accumulating a forward direction feeding mode, indicating the display order that is to be executed, and a backward direction feeding mode, indicating the display order that is to be executed is the reverse, in accordance with which the display order of the multiple image data is applied, and a control rule for each mode; and

a data control section referring to contents accumulated in the cache data accumulation section and the mode and the control rule accumulated in the storage section to perform control so that image data at display order positions lower than the image data of a particular image currently displayed on the display device are accumulated in the cache data accumulation section.

The data transmission method according to the present invention is a data transmission method implemented in an image display system comprising a transmission terminal including an image accumulation section accumulating multiple image data the display order of which is specified, and a display apparatus connected to the transmission terminal via a network and including a cache data accumulation section accumulating multiple image data sent from the transmission terminal and a display device displaying images of the image data accumulated in the cache data accumulation section, wherein the display device displays a particular image in response to an instruction input to the transmission terminal to the effect that the particular image is to be displayed, the method being characterized in comprising:

a forward direction feeding mode, indicating the display order that is to be executed, and a backward direction feeding mode, indicating the display order that is to be executed is the reverse, in accordance with which the display order of the multiple image data is applied, and a control rule for each mode; and

a data control section refers to contents accumulated in the cache data accumulation section and the mode and the control rule accumulated in the storage section to perform control so that image data at display order positions lower than the image data of a particular image currently displayed on the display device are accumulated in the cache data accumulation section.

### BRIEF DESCRIPTION OF THE DRAWINGS

FIG. 1 is a block diagram showing the configuration of main components of a first exemplary embodiment;

FIGS. 2(a) and 2(b) are diagrams showing examples of display on display section 105 in FIG. 1 and show an image data list screen and thumbnails, respectively;

FIG. 3 is a diagram showing an example of the configuration of image data management table 112 in FIG. 1;

FIG. 4 is a flowchart showing an operation performed when data control section 103 in FIG. 1 sets a state mode;

FIG. 5 is a flowchart showing an operation of controlling data performed by data control section 103;

FIG. 6 is a flowchart showing the operation of an image data transmission process shown in FIG. 5;

FIGS. 7(a) and 7(b) are diagrams showing content stored in cache management table 113;

FIG. 8 is a diagram showing content stored in cache data accumulation section 211;

FIG. 9 is a flowchart showing the operation of a forward-direction feeding process performed at step S504 in FIG. 5; and

FIG. 10 is a block diagram showing the configuration of main components of a first exemplary embodiment.

### DESCRIPTION OF SYMBOLS

1, 31 transmission terminal
2, 42 display apparatus
3, 53 network
101, 301 UI section
102, 302 UI monitoring section
103, 303 data control section
104, 304 data transmission section
105, 305 display section
106, 306 network connection section
107, 307 storage section
111, 311 image data accumulation section
112, 312 image data management table
113, 411 cache management table
201, 401 data output section
202, 402 data management section
203, 403 data receiving section
204, 405 display device
211, 412 cache data accumulation section

### BEST MODE FOR CARRYING OUT THE INVENTION

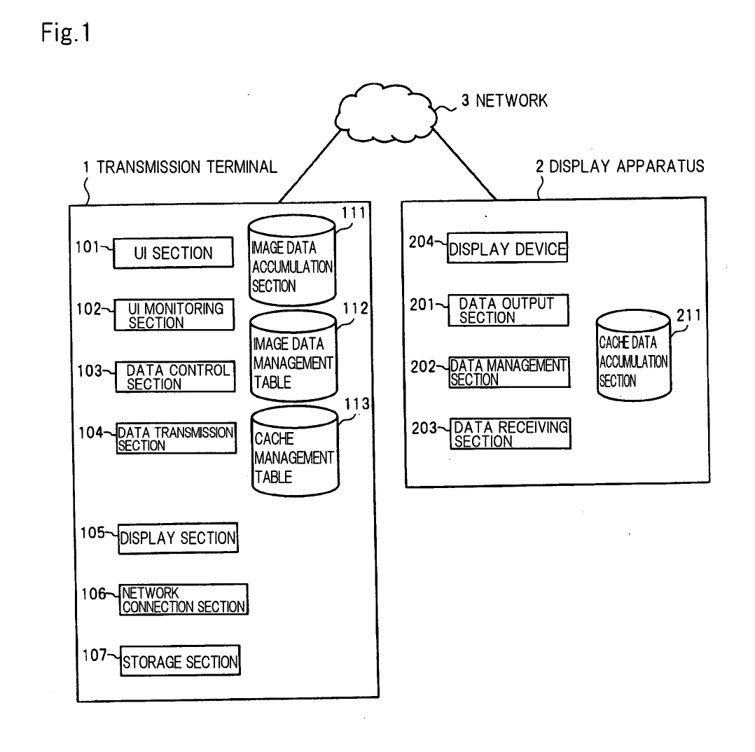

Next, exemplary embodiments will be described with reference to drawings. FIG. 1 is a block diagram showing the configuration of main components of a first exemplary embodiment.

This exemplary embodiment is configured by network 3, and by transmission terminal 1 and display apparatus 2 which can transmit and receive data via network 3. Transmission terminal 1 is provided with UI (user interface) section 101, UI monitoring section 102, data control section 103, data transmission section 104, display section 105, network connection section 106, storage section 107, image data accumulation section 111, image data management table 112 and a cache management table 113.

Display apparatus 2 is provided with data output section 201, data management section 202, data receiving section 203, display device 204 and cache data accumulation section 211.

In image data accumulation section 111, multiple image data are accumulated. Image data management table 112 manages the order of displaying the multiple images accumulated in image data accumulation section 111.

Cache data accumulation section 211 of display apparatus 2 is for accumulating multiple image data transmitted from transmission terminal 1, and the accumulated contents are managed by cache management table 113 of transmission terminal 1.

UI section 101 receives a control input or a key input to an operation screen by a user operation.

UI monitoring section 102 monitors the contents of an input by a user operation via UI section 101 and outputs a signal indicating the contents of the input to data control section 103.

Data control section 103 performs transmission of the image data accumulated in the image data accumulation section and control of the contents accumulated in cache data accumulation section 211 according to the contents of the input to UI section 101 shown in output of UI monitoring section 102, and a state mode and control rules accumulated in storage section 107. When accepting an image data transmission request, data control section 103 transmits image data specified by the image data transmission request and realizes an image data feeding function. The state mode accumulated in storage section 107 is updated according to the contents of the input.

In response to an instruction from data control section 103, data transmission section 104 transmits various kinds of command data to display apparatus 2 via network 3.

Display section 105 performs display; network connection section 106 performs an operation of connecting to network 3; and storage section 107 stores a state mode and control rules.

Data receiving section 203 receives command data transmitted from data transmission section 104 of transmission terminal 1 via the network.

Data management section 202 performs processing of various kinds of commands handed over from data receiving section 203, and data output section 201 displays data on the display device in response to a request by data management section 202.

The operation of this exemplary embodiment will be described below in detail. A device for displaying an image which is used for presentation in a meeting room or the like, such as a projector, is assumed to be display apparatus 2.

As an example of an operation that is commonly performed when a presentation is made, a situation in which an operator explains, from the first page, explanatory material that is made up of multiple pages will be described.

Concretely, the explanatory material is displayed with the use of image data showing the explanatory material. Here, it is assumed that one item of image data constitutes one screen (page) on display apparatus 2 for simplification of explanation. A page control operation for feeding the material page by page in a forward direction is expressed as “forward feeding”, and an operation of going back by one page is expressed as “backward feeding”. Other page controls include jump to a specified page and the like.

Commands to be used in the description below are configured to include information as shown below.

Image display command: a command ID and a cache number.

Cache registration command: a command ID, a registration-destination cache number and image data

Cache deletion command: a command ID and a deletion-destination cache number

In this exemplary embodiment, an image transmission function is realized by the operation below.

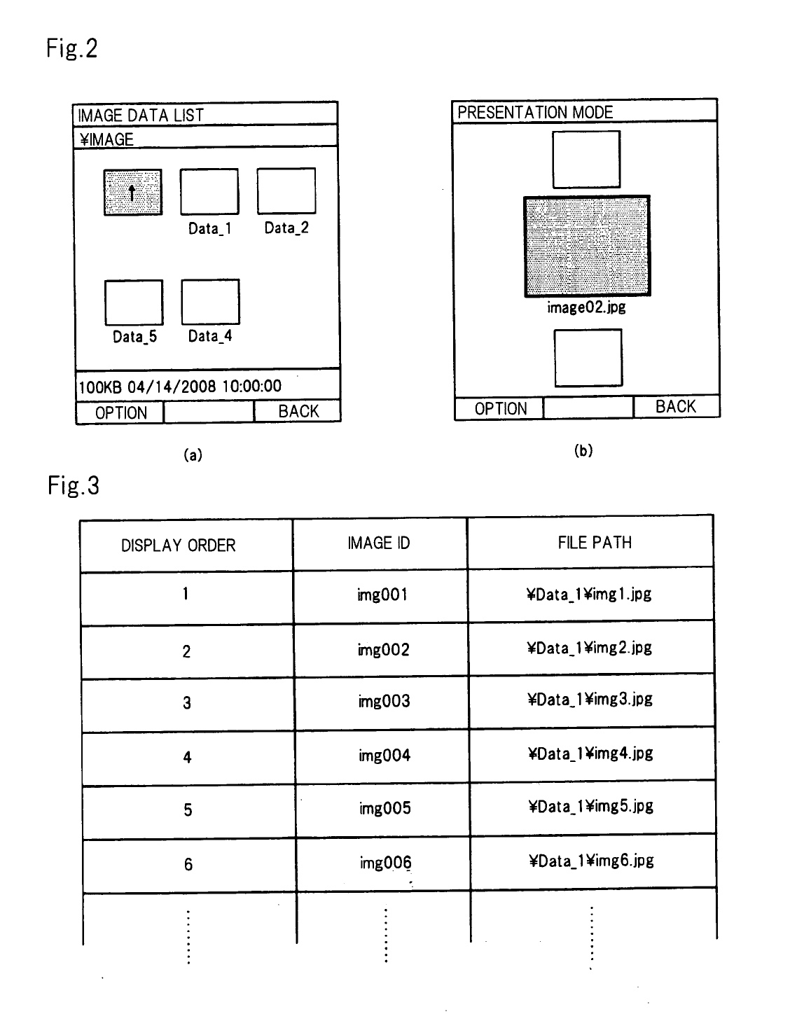

In order to cause an operator to select data to be transmitted, data control section 103 causes display section 105 to display an image data list screen as shown in FIG. 2 (a). In the example shown in FIG. 2(a), five folders Data_1 to Data_5 are presented. When the operator performs input for displaying thumbnails to input means in order to select any folder, thumbnails as shown in FIG. 2(b) are displayed.

The thumbnails shown in FIG. 2(b) are displayed on the basis of the image data accumulated in image data accumulation section 111, and any one of the five folders is in a state of focus that is displayed in an enlarged form. When the operator performs a transmission input to the effect that image data to be transmitted is selected, by moving the focus over the thumbnails with the use of a cursor movement key provided for the input means, image data of a currently focused thumbnail is transmitted to display apparatus 2, and the focus moves to the thumbnail of the next image data. Then, each time a transmission input is performed, transmission of image data of a focused thumbnail is performed, and the page is fed forward.

The details will be described below.

Data control section 103 refers to image data accumulation section 111 and image data management table 112 which is a management table of image data accumulation section 111, displays and controls the image data list screen shown in FIG. 2(a), the thumbnail screen shown in FIG. 2(b) and the like, and causes the operator to select image data to be transmitted.

When the operator selects image data and performs a transmission input, UI section 101 requests data control section 103 to transmit the selected image data.

FIG. 3 shows an example of the configuration of image data management table 112. A display order, image IDs uniquely assigned to images, locations of image data are managed.

UI monitoring section 102 monitors operations exchanged between UI section 101 and the operator and sets the following three state modes for storage section 107.

Forward feeding: a state in which an operator continuously performs forward-direction page feeding

Backward feeding: a state in which an operator continuously performs backward-direction page feeding

Pending: a state other than the above

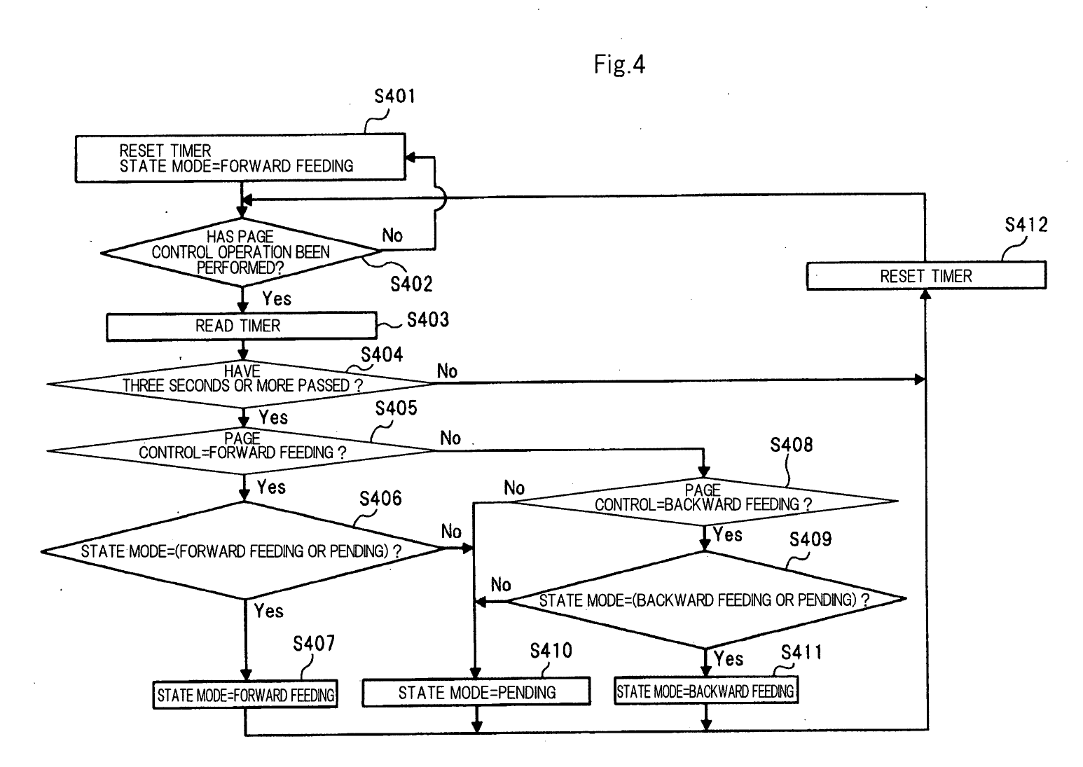

FIG. 4 is a flowchart showing an operation performed when data control section 103 sets a state mode. Here, the state mode is updated, with a page control operation performed as a trigger after three seconds or more have passed after the previous page control operation.

As an initial state, data control section 103 resets a timer (not shown) provided for transmission terminal 1 and sets the state mode as “forward feeding” for storage section 107 (step S401). Next, it is confirmed by an output from UI monitoring section 102 whether an operation of controlling a page feeding operation has been performed on UI section 101 (step S402). If the operation has not been performed, the timer is reset (step S412), and it is confirmed again whether the operation of controlling a page feeding operation has been performed on UI section 101.

If it is confirmed at step S402 that the operation of controlling a page feeding operation has been performed on UI section 101, the timer is read (step S403), and it is confirmed whether three seconds or more have passed (step S404). If three seconds or more have not passed, the timer is reset (step S412), and it is confirmed again whether the operation of controlling a page feeding operation has been performed on UI section 101.

If it is confirmed at step S404 that three seconds or more have passed, it is confirmed whether the performed page feeding operation control is “forward feeding” (step S405).

If it is confirmed at step S405 that the performed page feeding operation control is “forward feeding”, it is confirmed whether the mode set for storage section 105 is “forward feeding” or “pending” (step S406).

If it is confirmed at step S406 that the mode set for storage section 105 is “forward feeding” or “pending”, the state mode is set to “forward feeding” (step S407), the timer is reset (step S412), and it is confirmed again whether the operation of controlling a page feeding operation has been performed on UI section 101.

If it is confirmed at step S405 that the performed page feeding operation control is not “forward feeding”, it is confirmed whether the performed page feeding operation control is “backward feeding” (step S408), and it is confirmed whether the mode set for storage section 105 is “backward feeding” or “pending” (step S409).

If it is confirmed at step S406 that the mode set for storage section 105 is not “forward feeding” or “pending”, if it is confirmed at step S408 that the performed page feeding operation control is not “backward feeding”, or if it is confirmed at step S409 that the mode set for storage section 105 is not “backward feeding” or “pending”, the state mode is set to “pending” (step S410), the timer is reset (step S412), and it is confirmed again whether the operation of controlling a page feeding operation has been performed on UI section 101.

If it is confirmed at step S408 that the performed page feeding operation control is “backward feeding”, and if it is confirmed at step S409 that the mode set for storage section 105 is “backward feeding” or “pending”, the state mode is set to “backward feeding” (step S411), the timer is reset (step S412), and it is confirmed again that the operation of controlling a page feeding operation has been performed on UI section 101.

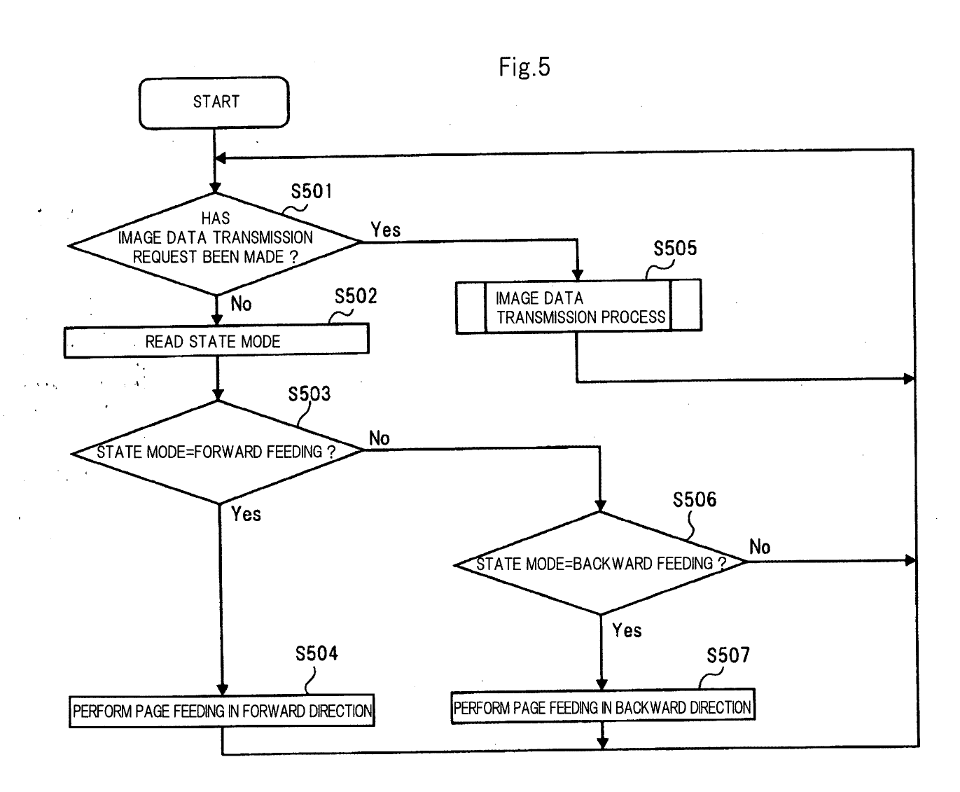

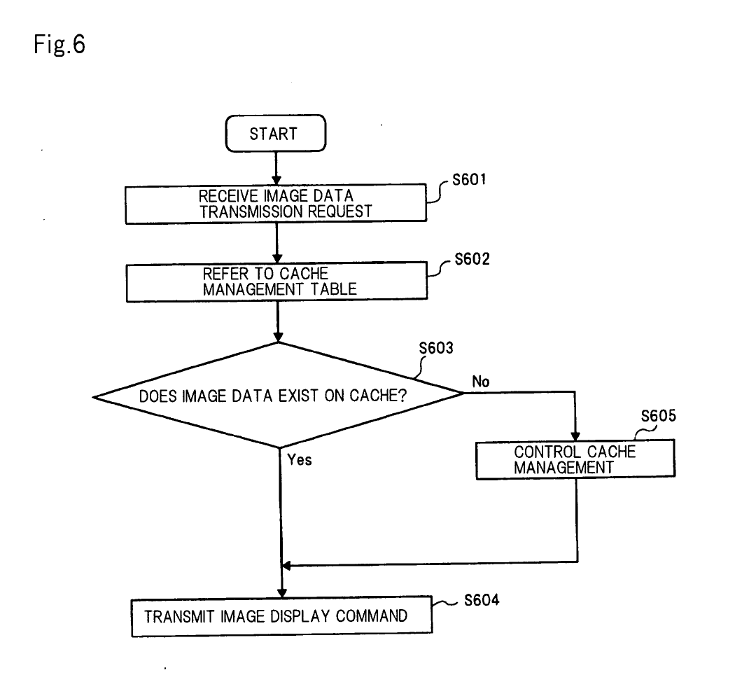

FIG. 5 is a flowchart showing the control operation by data control section 103, and FIG. 6 is a flowchart showing the operation of an image data transmission process shown in FIG. 5.

Data control section 103 confirms whether an image data transmission request has been made to UI section 101 by an output of UI monitoring section 102 (step S501). If the image data transmission request is made, the image data transmission process shown in FIG. 6 is performed, and it is confirmed again whether an image data transmission request has been performed.

If it is confirmed at step S501 that an image data transmission request has not been performed, the mode set for storage section 105 is read (step S502), it is confirmed whether the mode is “forward feeding” (step S503), and it is confirmed whether the mode is “backward feeding” (step S506).

If it is confirmed at step S503 that the mode is “forward feeding”, data control section 103 performs a process for feeding the page in a forward direction (step S504), returns to step 501 and confirms whether an image data transmission request has been made.

If it is confirmed at step S506 that the mode is “backward feeding”, data control section 103 performs a process for feeding the page in a backward direction (step S507), returns to step 501 and confirms whether an image data transmission request has been made.

The page feeding process performed at steps S504 and S507 will be described later. The image data transmission process performed at step S505 will be described with reference to FIG. 6.

When receiving an image data transmission request (step S601), data control section 103 refers to cache management table 113 (step S602) to confirm whether image data specified by the image data transmission request exists on cache data accumulation section 211 of display apparatus 2 (step S603).

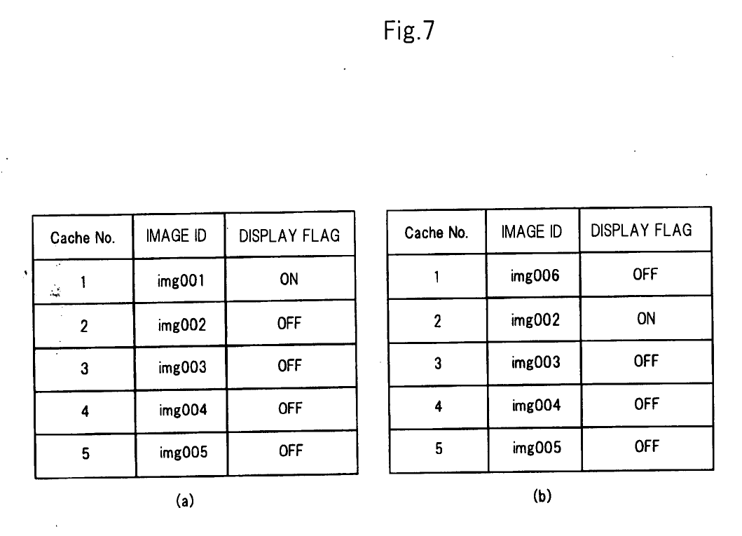

Each of FIGS. 7(a) and 7(b) is a diagram showing the contents stored in cache management table 113. It is seen that the cache has enough capacity to accumulate images corresponding to five pages. Cache management table 113 is constituted by cache numbers for identifying operation target cache data, image IDs for identifying images, and display flags for identifying an image currently displayed.

The example shown in FIG. 7(a) indicates a state in which an image with a cache number 1 and an image ID img001 is displayed. The example shown in FIG. 7(b) indicates a state in which an image with a cache number 2 and an image ID img002 is displayed.

If it is confirmed at step S603 that the image data that has been requested to be transmitted does not exist in the cache, cache control is performed (step S605). The cache control performed here will be described later.

If it is confirmed at step S603 that the image data that has been requested to be transmitted exists in the cache, a request to transmit an image display command is made to data transmission section 104 after step S605, and data transmission section 104 accepts the request from data control section 103 and transmits the image display command to display apparatus 2 (step S604).

When receiving the image display data command, data receiving section 203 of display apparatus 2 hands it over to data management section 202. Receiving the image display data command, data management section 202 reads image data shown in the image display command from cache data accumulation section 211 and instructs data output section 201 to display it. Data output section 201 displays it on a display device (not shown).

Next, the details of the cache management control performed at step S605 will be described.

If it is confirmed at step S603 that the image data that has been requested to be transmitted does not exist in cache data accumulation section 211, data control section 103 confirms whether there is space in cache data accumulation section 211. If there is sufficient capacity, data control section 103 refers to image data management table 112, creates a cache registration command, transmits it to display apparatus 2 via data transmission section 104, and updates cache management table 113.

If there is no space in cache data accumulation section 211, data control section 103 transmits a cache deletion command to make space to secure a cache area. After that, data control section 103 transmits a cache registration command to display apparatus 2 via data transmission section 104 similarly and updates cache management table 113. In this case, the data cache which is to be deleted is determined in accordance with control rules for feeding to be described later.

When receiving the cache registration command, data receiving section 203 of display apparatus 2 hands it over to data management section 202. Data management section 202 registers a cache number and image data shown in the received cache registration command with cache data accumulation section 211.

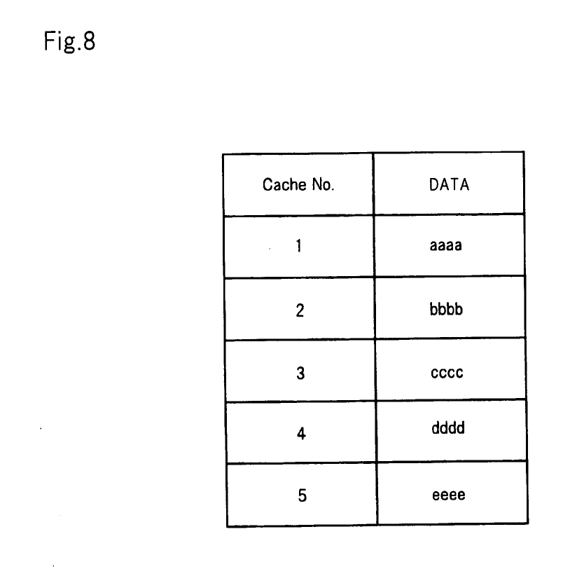

FIG. 8 is a diagram showing the contents stored in cache data accumulation section 211. As shown in the figure, image data are stored in association with cache numbers.

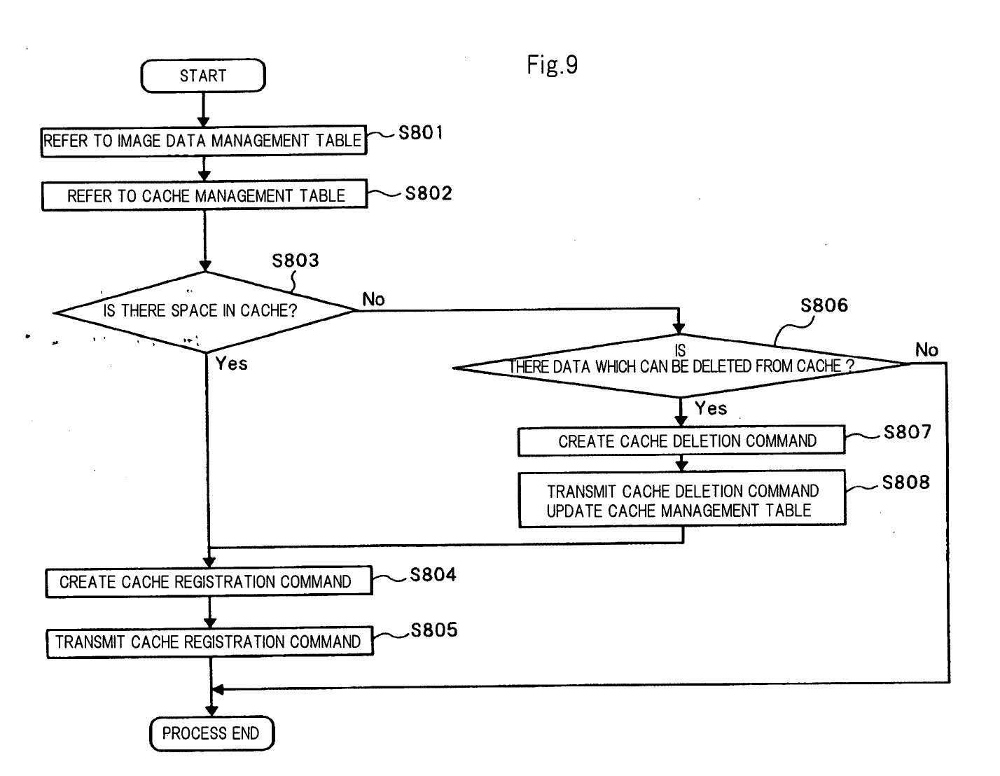

FIG. 9 is a flowchart showing the operation of a forward-direction feeding process performed at step S504 in FIG. 5. The operation will be described below with reference to FIG. 9. The control rules below are assumed to be applied to the feeding process.

### <Control Rules>

Feeding should be performed in the direction of a current state mode as far as possible; and
If there is no space in cache data accumulation section 211 any more, an image should be deleted which is positioned in a direction opposite to the direction of the state mode relative to the currently displayed image.

When the forward-direction feeding process is activated, data control section 103 refers to image data management table 112, selects the next feeding candidate (step S801), and then refers to cache management table 113 (step S802).

Next, data control section 103 confirms whether there is space in cache data accumulation section 211 (step S803) and, if there is space, creates a cache registration command (S804). Data control section 103 transmits the cache registration command to display apparatus 2 via data transmission section 104, updates cache management table 113 (step S805) and ends the process.

If it is confirmed at step S803 that there is no space in cache data accumulation section 211, it is confirmed whether there is cache data to be deleted, in accordance with the control rules (step S806).

If it is confirmed at step S806 that there is no data to be deleted, data control section 103 ends the process.

If it is confirmed at step S806 that there is data which can be deleted, data control section 103 creates a cache deletion command (step S807), transmits it to display apparatus 2 via the transmission section, updates cache management table 113 (step S808), and proceeds to step S804.

When receiving the cache deletion command, data receiving section 203 of display apparatus 2 hands it over to data management section 202. Data management section 202 discards the data of a cache number shown in the handed-over cache deletion command and updates cache data accumulation section 211.

When receiving a cache registration command, data receiving section 203 of display apparatus 2 hands it over to data management section 202. Data management section 202 registers a cache number and image data shown in the handed-over cache registration command with cache data accumulation section 211.

The above operation will be described with the use of the examples shown in FIG. 7.

FIG. 7(a) shows cache management table 113 in a state in which an image with an image ID img001 is displayed in state mode=forward feeding, and five pages are cached after execution of feeding.

Next, consideration will be made on the case where an operator performs a page forward-feeding operation in the above state to display (the image) img002, and then, the next feeding is executed when three or more seconds have passed. Data control section 103 performs an operation as described below.

Data control section 103 refers to image data management table 112 and determines the image data candidate to be fed in a forward direction next. Here, an image at a display order position=6 and with an image ID img006 becomes a candidate. Since there is no space in the cache, data control section 103 creates a cache deletion command to delete the image img001 positioned in a direction opposite to the direction of the state mode relative to the currently displayed image img002, from the cache in accordance with the control rules, transmits the cache deletion command to display apparatus 2 via data transmission section 104, and updates cache management table 113.

Then, data control section 103 creates a cache registration command for img06, transmits it to the display apparatus via the data transmission section, and updates cache management table 113. Cache management table 113 in this state is shown in FIG. 7(b).

The “control rules” shown here are only an example. For example, another rule is also conceivable in which at least one page before and after a currently displayed image is left in the cache.

Furthermore, it is also possible to prepare multiple control rules and present the contents of the control rules to a user via UI section 101 to cause the user to select a control rule suitable for the user's style of performing an operation, and such a configuration may be made.

It is also conceivable to implement a configuration in UI control section 102, data control section 103 or the like in which image data specified by an image data transmission request by an operator are measured and the characteristics of the image data specified by the operator are extracted to change rules to be applied or to update the contents of the rules themselves.

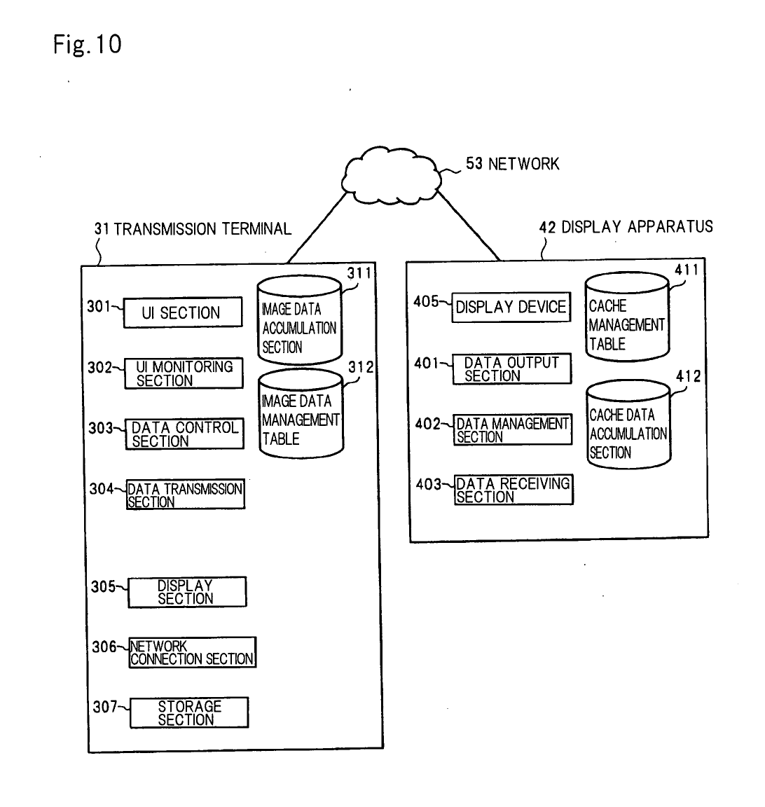

Next, a second exemplary embodiment will be described with reference to FIG. 10 which is block diagram showing main components thereof.

Though the cache data management and data feeding management functions are implemented on the transmission terminal side in the first exemplary embodiment, those functions are implemented on the display apparatus side in this exemplary embodiment.

This exemplary embodiment is configured by network 53, transmission terminal 31 and display apparatus 42 which can transmit and receive data via network 53.

In this exemplary embodiment, UI section 301, UI monitoring section 302, data control section 303, data transmission section 304, display section 305, network connection section 306, storage section 307, image data accumulation section 311 and image data management table 312 constituting transmission terminal 31, and data output section 401, data management section 402, data receiving section 403, display device 405 and cache data accumulation section 412 constituting display apparatus 42 perform operations similar to those of UI section 101, UI monitoring section 102, data control section 103, data transmission section 104, display section 105, network connection section 106, storage section 107, image data accumulation section 111 and image data management table 112 constituting transmission terminal 1, and data output section 201, data management section 202, data receiving section 203, display device 204 and cache data accumulation section 211 constituting display apparatus 2 which are shown in FIG. 1, respectively.

In this exemplary embodiment, the cache management table provided on the transmission terminal side in the first exemplary embodiment is cache management table 411 provided in display apparatus 42.

Data control section 303 refers to cache management table 411 via network 53 to confirm the contents stored in cache data accumulation section 412. Other control operations are similar to those in the first exemplary embodiment.

Though it is assumed that the state mode is the forward feeding mode at the initial state and determined by the data control section in accordance with the contents of an input to the UI section afterwards, it may be directly set by a user.

By making a configuration as described above, it is possible to realize functions similar to those of the first exemplary embodiment. Thus, any of the cache management table, the data control section and the storage section may be provided in any of the transmission terminal and the display apparatus constituting the image display system.

According to the exemplary embodiments described above, since it is possible to cause data accumulated as cache data to be displayed afterwards, it is possible to quickly display an image even in a network environment having a relatively narrow band.

1. An image display system comprising a transmission terminal including an image accumulation section accumulating multiple image data the display order of which is specified, and a display apparatus connected to the transmission terminal via a network and including a cache data accumulation section accumulating multiple image data sent from the transmission terminal and a display device displaying images of the image data accumulated in the cache data accumulation section, wherein the display device displays a particular image in response to an instruction input to the transmission terminal to the effect that the particular image is to be displayed, the image display system comprising:
a storage section accumulating a forward direction feeding mode, indicating the display order that is to be executed, and a backward direction feeding mode, indicating the display order that is to be executed is the reverse, in accordance with which the display order of the multiple image data is applied, and a control rule for each mode; and
a data control section referring to contents accumulated in the cache data accumulation section and the mode and the control rule accumulated in the storage section to perform control so that image data at display order positions lower than the image data of a particular image currently displayed on the display device are accumulated in the cache data accumulation section.

2. The image display system according to claim 1, wherein the control rule is: the contents accumulated in the cache data accumulation section are to be referred to, and image data positioned in a direction opposite to the direction of the current feeding mode relative to a particular image currently displayed is to be deleted to cause image data at display order positions lower than the image data of the particular image to be accumulated in the cache data accumulation section.

3. A transmission terminal connected to a display apparatus including a cache data accumulation section accumulating received multiple image data and a display device displaying images of the image data accumulated in the cache data accumulation section via a network to constitute an image display system, the transmission terminal comprising an image accumulation section accumulating multiple image data the display order of which is specified and which are to be transmitted to the display apparatus and causing a particular image to be displayed on the display device in response to an instruction input to the effect that the particular image is to be displayed, and the transmission terminal comprising:
a storage section accumulating a forward direction feeding mode, indicating the display order that is to be executed, and a backward direction feeding mode, indicating the display order that is to be executed is the reverse, in accordance with which the display order of the multiple image data is applied, and a control rule for each mode; and
a data control section referring to contents accumulated in the cache data accumulation section and the mode and the control rule accumulated in the storage section to perform control so that image data at display order positions lower than the image data of a particular image currently displayed on the display device are accumulated in the cache data accumulation section.

4. A display apparatus connected to a transmission terminal including an image accumulation section accumulating multiple image data the display order of which is specified, via a network, to constitute an image display system, and comprising a cache data accumulation section accumulating multiple image data sent from the transmission terminal and a display device displaying images of the image data accumulated in the cache data accumulation section, the display device displaying a particular image in response to an instruction input to the transmission terminal to the effect that the particular image is to be displayed, and the display apparatus comprising:
a storage section accumulating a forward direction feeding mode, indicating the display order that is to be executed, and a backward direction feeding mode, indicating the display order that is to be executed is the reverse, in accordance with which the display order of the multiple image data is applied, and a control rule for each mode; and
a data control section referring to contents accumulated in the cache data accumulation section and the mode and the control rule accumulated in the storage section to perform control so that image data at display order positions lower than the image data of a particular image currently displayed on the display device are accumulated in the cache data accumulation section.

5. A data transmission method implemented in an image display system comprising a transmission terminal including an image accumulation section accumulating multiple image data the display order of which is specified, and a display apparatus connected to the transmission terminal via a network and including a cache data accumulation section accumulating multiple image data sent from the transmission terminal and a display device displaying images of the image data accumulated in the cache data accumulation section, wherein the display device displays a particular image in response to an instruction input to the transmission terminal to the effect that the particular image is to be displayed, the method comprising:
a forward direction feeding mode, indicating the display order that is to be executed, and a backward direction feeding mode, indicating the display order that is to be executed is the reverse, in accordance with which the display order of the multiple image data is applied, and a control rule for each mode; and
a data control section refers to contents accumulated in the cache data accumulation section and the mode and the control rule accumulated in the storage section to perform control so that image data at display order positions lower than the image data of a particular image currently displayed on the display device are accumulated in the cache data accumulation section.
